(19) United States
(12) Patent Application Publication
(10) Pub. No.: US 2025/0033670 A1
(43) Pub. Date: Jan. 30, 2025

(54) REMOTE ASSISTANCE SYSTEMS FOR AUTONOMOUS VEHICLES

(71) Applicant: GM Cruise Holdings LLC, San Francisco, CA (US)

(72) Inventors: Alexander Boule, Silver Spring, MD (US); Curtis Aaron Boushley, Issaquah, WA (US)

(21) Appl. No.: 18/360,777

(22) Filed: Jul. 27, 2023

(51) Int. Cl. B60W 60/00; B60W 50/02; G05D 1/00

(52) U.S. Cl. CPC B60W 60/0018; B60W 50/02; B60W 2420/403; B60W 2420/408; B60W 2556/45

(57) ABSTRACT

Systems and techniques are provided for translating outputs from machine learning (ML) models of an autonomous vehicle (AV) and generating a remote assistance (RA) interface based on the translated outputs. An example method can include receiving an output generated by an ML model of an AV, the output indicating a navigation action and/or a likelihood that the AV will implement the navigation action in a scene associated with the AV; in response to an error event experienced by the AV, establishing an RA session between the AV and an RA system; translating the output into a navigation constraint associated with the navigation action, the navigation constraint representing a condition deemed to restrict a behavior of the AV in the scene to the navigation action or trigger the AV to implement the navigation action; and generating an RA interface comprising user interface (UI) data representing the navigation constraint.

### TECHNICAL FIELD

The present disclosure generally relates to remote assistance systems for autonomous driving. For example, aspects of the present disclosure relate to systems and techniques for translating autonomous vehicle data for use by remote assistance operators to provide remote assistance to autonomous vehicles.

### BACKGROUND

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at specific locations on the autonomous vehicles.

### BRIEF DESCRIPTION OF THE DRAWINGS

Illustrative examples and aspects of the present application are described in detail below with reference to the following figures:

FIG. 1 is a diagram illustrating an example system environment that can be used to facilitate autonomous vehicle navigation and routing operations, according to some examples of the present disclosure;

FIG. 2 is a diagram illustrating an example system flow for translating outputs from a model of an autonomous vehicle and generating remote assistance interface data based on the translated outputs from the model, according to some examples of the present disclosure;

FIG. 3 is a diagram illustrating an example translation of an output from a model of an autonomous vehicle, according to some examples of the present disclosure;

FIG. 4 is a diagram illustrating an example of a remote assistance interface generated based on a translation of an output of a model of an autonomous vehicle, according to some examples of the present disclosure;

FIG. 5 is a flowchart illustrating an example process for translating outputs from models of an autonomous vehicle and generating remote assistance interface data based on the translated outputs from the models, according to some examples of the present disclosure; and

FIG. 6 is a diagram illustrating an example system architecture for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of aspects and examples of the application. However, it will be apparent that various aspects and examples may be practiced without these specific details. The figures and description are not intended to be restrictive.

The ensuing description provides aspects and examples of the disclosure, and is not intended to limit the scope, applicability, or configuration of the disclosure. Rather, the ensuing description of the aspects and examples of the disclosure will provide those skilled in the art with an enabling description for implementing an example implementation of the disclosure. It should be understood that various changes may be made in the function and arrangement of elements without departing from the scope of the application as set forth in the appended claims.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

As previously explained, autonomous vehicles (AVs) can include various sensors, such as a camera sensor, a light detection and ranging (LIDAR) sensor, a radio detection and ranging (RADAR) sensor, a time-of-flight (TOF) sensor, an inertial measurement unit (IMU), and/or an acoustic sensor (e.g., sound navigation and ranging (SONAR), microphone, etc.), global navigation satellite system (GNSS) and/or global positioning system (GPS) receiver, amongst others. The AVs can use the various sensors to collect data and measurements that the AVs can use for AV operations such as perception (e.g., object detection, event detection, tracking, localization, sensor fusion, point cloud processing, image processing, etc.), planning (e.g., route planning, trajectory planning, situation analysis, behavioral and/or action planning, mission planning, etc.), control (e.g., steering, braking, throttling, lateral control, longitudinal control, model predictive control (MPC), proportional-derivative-integral, etc.), prediction (e.g., motion prediction, behavior prediction, etc.), etc. The sensors can provide the data and measurements to an internal computing system of the autonomous vehicle, which can use the data and measurements to control a mechanical system of the autonomous vehicle, such as a vehicle propulsion system, a braking system, and/or a steering system, for example.

An AV can implement artificial intelligence (AI) and machine learning (ML) models to process data, such as sensor data, that the AI/ML models can use to make or generate various outputs, decisions, calculations, and/or predictions that the AV can use to operate in an environment. For example, an AV can implement an AI/ML model(s) to detect objects in a scene, predict movements of objects in the scene, and make navigation decisions/predictions. The AV can use AI/ML models along with other software tools and algorithms to make decisions, generate outputs, perform calculations, perform tasks, and/or make predictions used by the AV to navigate the environment. Nevertheless, in some cases, the AV can experience error events that may cause the AV to become stuck in a scene (e.g., unable to continue navigating or complete a maneuver without assistance) and/or may trigger the AV to request assistance from a remote assistance operator.

For example, if the AV is unable to detect a traffic signal in an intersection or the traffic signal is not functioning, the AV may decide to stop rather than crossing the intersection because the AV has not detected a signal from the traffic signal indicating that the AV can cross the intersection. In this example, the AV may then need assistance from a remote assistance operator to traverse the intersection, as the remote assistance operator can instruct the AV whether to remain stopped, cross the intersection (while still monitoring for obstructions and other actors) despite the failure to detect a signal from the traffic signal, or perform another maneuver. When (e.g., before, during, and/or after) requesting and/or receiving assistance from the remote assistance operator, the AV can provide the remote assistance operator data collected by the AV in the scene, such as sensor data, that the remote assistance operator can use to understand the scene, understand the AV's need for assistance, and/or determine how to assist the AV. For example, the remote assistance operator may analyze data from the AV describing the scene and/or the state of the AV, to determine whether the AV can actually proceed through the intersection despite the lack of such an indication by the traffic signal. The remote assistance operator can then provide the AV instructions on how to proceed (e.g., how and/or whether to cross the intersection, etc.). In some examples, the remote assistance operator can instruct the AV on how to proceed by sending data (e.g., a command or instruction, routing/navigation data, parameters, etc.) to the AV that the AV can use to overcome the error event (e.g., to continue through the intersection). The data from the remote assistance operator can include, for example and without limitation, instructions (e.g., a command(s), a task(s), etc.), routing/navigation data, parameters, context of the scene (e.g., the traffic light is not operating and/or should be treated as a stop sign or an unprotected intersection), etc. For example, the data can include one or more commands configured to trigger one or more actions and/or tasks by the AV, one or more instructions or settings overturning a decision of the AV (e.g., the AV's decision to stop at the intersection), parameters or settings removing a constraint that caused the error event (e.g., a restriction preventing the AV from traversing the intersection if the AV was unable to detect the traffic signal or the traffic signal is not functioning), etc.

In some examples, a remote assistance operator can provide remote assistance to an AV using a remote assistance system that allows the remote assistance operator to remotely interact with the AV. The remote assistance system may provide data from the AV (e.g., sensor data, log data, planning data, model outputs, etc.) to a display device that the remote assistance operator can use to analyze the data in order to determine how to assist the AV. The remote assistance operator can provide inputs through the remote assistance system to remotely assist the AV. However, some of the data from the AV that a remote assistance operator may need to rely on to assist the AV may not be intuitive to a remote assistance operator (e.g., some of the data may not be intuitive to a human), may be difficult for a remote assistance operator (e.g., a human) to understand, or may even be unintelligible to a remote assistance operator. For example, it may be easier for a human to understand visual data depicting a scene of the AV, semantic elements in the scene, and any events in the scene than other non-visual data, data without labels/descriptions of semantic elements (or with labels/descriptions configured for consumption by a computer of the AV that may not be intuitive to a human), and/or other type of data that may be used by the computer of the AV to perform AV tasks such as perception, planning, navigation, etc. In many cases, the data from the AV, such as sensor data and/or outputs from models used by the AV, may be difficult for a human to understand or interpret as it may not be in a form, structure, format, scheme, etc., that is intended for human consumption (e.g., is intended for use or processing by a computer of the AV) and/or that can be understood by a human (or easily understandable to a human).

To illustrate, an output from an AV model(s) describing a scene, navigation options of the AV, and/or navigation decisions of the AV may include a string(s) of values (e.g., numeric values, non-numeric values, etc.). The string(s) of values may represent a condition, an event, an object, a prediction, a decision, an option, a setting, a parameter, a probability, and/or anything else that the AV software can use to operate the AV. The AV software may be configured to understand, interpret, and process the string(s) of values, which may be difficult for a human to understand/interpret in a timely fashion or may even be unintelligible to a human. For example, an output from an AV model(s) regarding an intersection that the AV is approaching (or has approached) can include coordinates associated with the intersection, one or more values representing navigation options estimated by the AV model(s) for the AV, and one or more costs (e.g., weights, probabilities, etc.) associated with the one or more values representing the navigation options-all of which may be difficult for a human to understand in a timely fashion. Such outputs may be designed for consumption/processing by a computer of the AV and may not be designed for ease of human consumption/interpretation.

In the previous example, the AV software may generate an output that includes a cost associated with a navigation option. To the AV software, the output can provide a likelihood/probability that the AV will select and implement the navigation option. The AV software can interpret such output to understand the scene and/or determine how to navigate the scene. However, to a human, such output may be difficult to interpret or otherwise unintelligible. Thus, a remote assistance operator may have difficulty interpreting such data and/or relying on such data when attempting to assist the AV through a remote assistance system.

In some cases, the data from an AV model(s) may even be encrypted, obfuscated, or otherwise unintelligible to a human. For example, the data may include a hash value representing and/or encoding information about the scene, such as coordinates, navigation options, costs (e.g., weights, probabilities) associated with the navigation options, conditions associated with the navigation options, navigation constraints, and/or any other information. The AV software may be able to understand and process the hash value. However, a human may not be able to interpret or understand the hash value and thus may miss information that can help the human assist the AV or that the human may need to assist the AV. Moreover, data from different AV models and/or software may vary in format, type, structure, content, and/or any other way. This can further increase the difficulty for a human to understand or interpret data from different AV models and/or software. For example, the outputs from different AV models may not be standardized in a way that may make it easier or possible for a human to interpret or understand. Even if the data from different AV models and/or software can be reasonably understood by humans, the humans may need to be trained on how to interpret such non-standardized data, which can increase costs, and/or may not be able to interpret such data in a timely fashion given the often time-sensitive nature of remote assistance events experienced by AVs.

Systems, apparatuses, processes (also referred to as methods), and computer-readable media (collectively referred to as “systems and techniques”) are described herein for translating autonomous vehicle data for use (e.g., easy understanding and consumption) by remote assistance operators to provide remote assistance to autonomous vehicles. In some examples, the systems and techniques described herein can translate a non-visual output(s) from an AI/ML model(s) implemented by an AV into visual data (e.g., visual user interface data) depicting a navigation constraint associated with the non-visual output(s) from the AI/ML model(s) implemented by the AV. When the AV encounters an error event (e.g., a stuck condition in which the AV needs and/or requests assistance from a human operator to overcome the stuck condition, a navigation failure, an inability to navigate a scene and/or perform a maneuver without assistance from a human operator, etc.), the AV can establish a remote assistance session with a remote assistance system that provides a remote assistance interface that a remote assistance operator can use to provide remote assistance to the AV. To facilitate the remote assistance, the systems and techniques described herein can provide the translated visual data to the remote assistance interface used by the remote assistance operator to provide remote assistance to the AV. The visual data can visually interpret and/or represent the non-visual output(s) from the AI/ML model(s) implemented by the AV.

For example, the visual data can translate a non-visual, weighted decision (and/or non-visual data representing or reflecting a cost associated with a navigation action) generated by an AI/ML model of the AV into visual data that depicts the translated non-visual, weighted decision (and/or non-visual data representing or reflecting a cost associated with a navigation action) generated by the AI/ML model. The remote assistance system can provide the visual data depicting the translated non-visual, weighted decision (and/or non-visual data representing or reflecting a cost associated with a navigation action) to a remote assistance interface used by a remote assistance operator to provide remote assistance to the AV. In some cases, the visual data can translate the non-visual, weighted decision (and/or non-visual data representing or reflecting a cost associated with a navigation action) generated by the AI/ML model into a navigation constraint associated with an error event that is/was encountered by the AV and relates to the non-visual weighted decision (and/or non-visual data representing or reflecting a cost associated with a navigation action) from the AI/ML model. The visual data can be used to visually represent the navigation constraint associated with the error event in the remote assistance interface for the remote assistance operator.

To illustrate, the visual data can be used to visually depict, in a remote assistance interface, a stop line representing a navigation constrain detected by the AV that the AV has determined (e.g., via an output from an AI/ML model) to stop for (and/or has determined that it prevents the AV from traversing an area associated with the navigation constraint). The remote assistance operator can interact with the stop line (e.g., via the remote assistance interface) to assist the AV. For example, the remote assistance operator can provide, via the remote assistance interface, an input configured to remove the stop line as a navigation constraint for the AV. Data representing the removal of the stop line as a navigation constraint can be sent to the AV (e.g., via the remote assistance system), which the AV (e.g., a software stack of the AV) can interpret as a waiver/removal of the navigation constraint, an instruction to proceed across an area in the scene corresponding to the stop line, and/or an instruction to ignore the navigation constraint. Thus, by removing the stop line from the remote assistance interface, the remote assistance operator can enable the AV to overcome the error event associated with the navigation constraint and/or transition from a stopped/stuck state triggered by the navigation constraint to a moving state that allows the AV to continue along a route.

In some aspects, the systems and techniques described herein can standardize outputs from AI/ML models of an AV and/or translate the outputs as generated, consumed, and/or processed by AI/ML models of the AV to a different format, type, structure, content, and/or presentation that is/are configured for consumption by a human remote assistance operator. For example, as previously noted, the data from an AV model(s) may be encrypted, obfuscated, difficult to interpret by a human, or otherwise unintelligible to a human. To illustrate, in some cases, the data from the AV model(s) may include a string or hash value representing and/or encoding information about the scene, navigation options, costs (e.g., weights, probabilities) associated with the navigation options, conditions associated with the navigation options, navigation constraints, and/or any other relevant information. The AV software may be able to interpret and process the string or hash value. However, a human may not be able to interpret or understand the string or hash value and thus may miss information that can help the human assist the AV or that the human may need to assist the AV. Moreover, data from different AV models and/or software may vary in format, type, structure, content, and/or any other way. This can further increase the difficulty for a human to understand or interpret data from different AV models and/or software. For example, the outputs from different AV models may not be standardized in a way that may make it easier or possible for a human to interpret or understand. Even if the data from different AV models and/or software can be reasonably understood by humans, the humans may need to be trained on how to interpret such non-standardized data, which can increase costs, and/or may not be able to interpret such data in a timely fashion given the often time-sensitive nature of remote assistance events experienced by AVs.

The systems and techniques described herein can standardize data generated based on outputs from AV models for presentation to and consumption by a human, such as a remote assistance operator. The standardized data can represent and/or describe the outputs (and/or aspects thereof) from the AV models. In some examples, the standardized data can be generated by translating the outputs from the AV models into data having certain characteristics designed to facilitate a human in interpreting/understanding such data in a timely fashion (e.g., within a threshold amount of time which can depend on how time-sensitive an AV's need for remote assistance). For example, the standardized data can be generated by translating outputs from the AV models into data representative and/or descriptive of such outputs and configuring such data to have/include a different format, type, structure, content, and/or presentation that is/are selected to facilitate a human remote assistance operator's ability to understand and/or interpret such data and provide assistance to the AV based on such data.

To illustrate, assume that the output from an AV model includes a string or hash value representing and/or encoding information about the scene, navigation options, costs (e.g., weights, probabilities) associated with the navigation options, conditions associated with the navigation options, navigation constraints, and/or any other relevant information. Here, a remote assistance operator may have difficulty interpreting and/or understanding (or may be unable to interpret and/or understand) the string or hash value from the AV model. However, the systems and techniques described herein can generate data representing and/or describing the string or hash value, and configure the data to have or include a particular format, structure, type, content, and/or presentation that is easier for a human to interpret and/or understand, such as visual data and/or data with descriptors in natural language. Such data (e.g., the associated format, structure, type, presentation, etc.) can be standardized so that translated data generated from outputs by different AV models have one or more common characteristics and/or reduces the variability between such data. This in turn can make it easier for a remote assistance operator to interpret and/or understand such data, reduce or eliminate time and costs in otherwise training remote assistance operators to understand and/or interpret data from different AV models, and reduce the time it may take a remote assistance operator to understand/interpret the data and provide assistance to the AV.

As another example, in some cases, an output from an AV model(s) describing a scene, navigation options of the AV, and/or navigation decisions of the AV may include one or more values configured for processing and/or interpretation by one or more AV models. On the other hand, the one or more values may be difficult for a human to understand/interpret in a timely fashion or may even be unintelligible to a human. For example, an output from an AV model(s) regarding an intersection that the AV is approaching (or has approached) can include one or more values representing coordinates associated with the intersection, navigation options estimated by the AV model(s) for the AV, and/or one or more costs (e.g., weights, probabilities, etc.) associated with the navigation options. The one or more values may be difficult for a human to understand as such one or more values may instead be designed for consumption/processing by one or more AV models. However, the systems and techniques described herein can translate the one or more values and generate translated data configured for consumption by a human. In some examples, if the one or more values represent a navigation decision of the AV in a scene, the translated data can include visual interface data used to depict to a human the navigation decision and/or a constraint resulting in the navigation decision.

In other examples, if the one or more values represent a navigation option of the AV in a scene and a cost associated with the navigation option, the systems and techniques described herein can determine whether the cost exceeds a threshold. If the cost exceeds the threshold, the systems and techniques described herein can determine that the AV will select (or has a threshold likelihood of selecting) the navigation option for implementation by the AV. To illustrate, if the navigation option includes stopping at a location associated with a stop light and the cost is above the threshold, the systems and techniques described herein can determine that the AV will stop (or has a threshold likelihood of stopping) at the location associated with the stop light. In other words, if the cost is above the threshold, the systems and techniques described herein can assume that the AV will stop at the location based on a probability reflected by the cost. The systems and techniques described herein can translate such assumption into data describing a constraint (e.g., a failure by the AV to detect a signal of the traffic signal indicating whether the AV should stop before the stop light or continue) identified as a reason for the AV stopping at the location associated with the stop light until the AV receives instructions indicating that the AV can proceed (e.g., traverse the stop location associated with the stop light). The data can include descriptive information that a human can more easily understand (e.g., information in natural language) and/or can be configured to visually depict the constraint identified as the reason for the AV stopping at the location. The data can be presented in a remote assistance interface that a remote assistance operator can use to assist the AV based on the data (e.g., by removing the constraint and/or enabling the AV to ignore the constraint in order to trigger the AV to continue navigating a route).

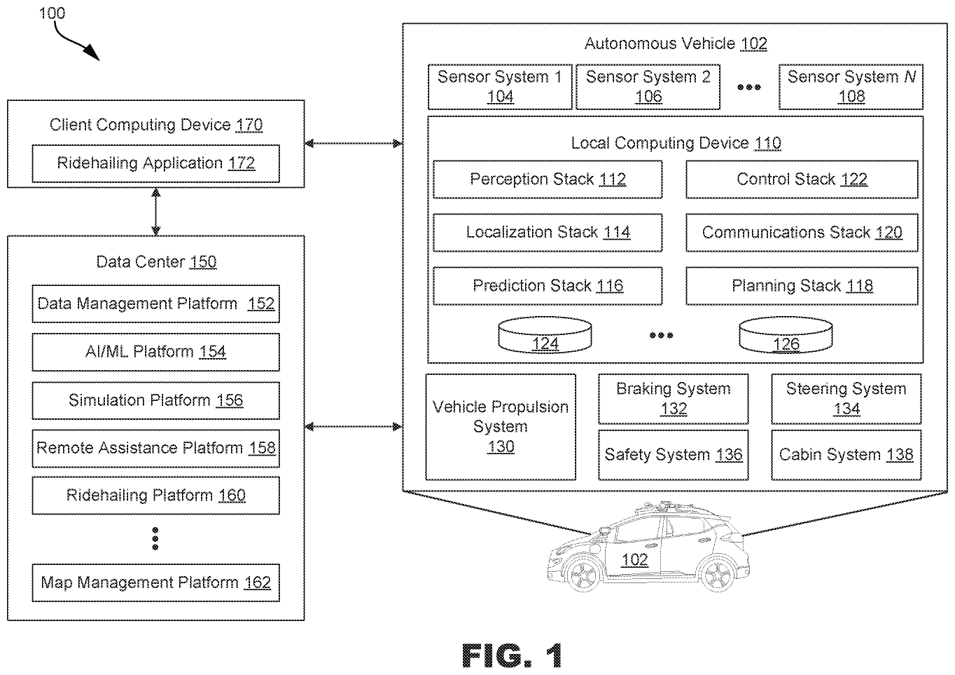

Examples of the systems and techniques described herein for processing data are illustrated in FIG. 1 through FIG. 6 and described below.

FIG. 1 is a diagram illustrating an example autonomous vehicle (AV) environment 100, according to some examples of the present disclosure. One of ordinary skill in the art will understand that, for the AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by sensor systems 104, 106, and 108. The sensor systems 104-108 can include one or more types of sensors and can be arranged about the AV 102. For instance, the sensor systems 104-108 can include one or more inertial measurement units (IMUs), camera sensors (e.g., still image camera sensors, video camera sensors, etc.), light sensors (e.g., LIDARs, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, time-of-flight (TOF) sensors, seat occupancy sensors, open/closed door sensors, tire pressure sensors, rain sensors, and so forth. For example, the sensor system 104 can include a camera system, the sensor system 106 can include a LIDAR system, and the sensor system 108 can include a RADAR system. Other examples may include any other number and type of sensors.

The AV 102 can include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and/or the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and/or other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

In some examples, the planning stack 118 can include multiple planning stacks and/or multiple planners (e.g., multiple planning stacks, multiple planning algorithms, multiple planning models, multiple planning nodes, multiple planning software and/or services, and/or multiple planning components) that the AV 102 can use to perform different maneuvers (and/or types of maneuvers), implement different parameters (e.g., different rules, different restrictions, different metrics, different standards, different states, and/or different behaviors), and/or navigate different scenes/environments (and/or types of scenes/environments), different conditions, different limitations, etc. For example, in some cases, the planning stack 118 can include a navigation planner and a specialized planner, as previously described. In some examples, the planning stack 118 can additionally or alternatively include other planners and/or a different number of planners. The local computing device 110 can intelligently and autonomously switch between different planners in/of the planning stack 118, as further described herein. For example, the local computing device 110 can autonomously switch between different planners in/of the planning stack 118 based on one or more factors such as, without limitation, a traffic rule, a restriction, a behavior, a scene, a state of the AV 102, a metric, a condition, a limitation, etc.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

Moreover, the local computing device 110 of the AV 102 can implement one or more AI/ML models to process data that the AI/ML models can use to make or generate various outputs, decisions, calculations, and/or predictions that the AV 102 can use to operate in an environment. For example, the perception stack, the localization stack 114, the prediction stack 116, the planning stack 188, the communications stack 120, the control stack 122, and/or any other software stack of the AV 102 can implement one or more AI/ML models used to process AV data.

The HD geospatial database 126 can store HD maps and related data of the streets upon which the AV 102 travels. In some examples, the HD maps and related data can include multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridehailing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridehailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridehailing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162 and/or a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridehailing platform 160 can interact with a customer of a ridesharing service via a ridehailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridehailing application 172. In some cases, the client computing device 170 can be a customer's mobile computing device or a computing device integrated with the AV 102 (e.g., the local computing device 110). The ridehailing platform 160 can receive requests to pick up or drop off from the ridehailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs (e.g., AV 102), Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridehailing platform 160 may incorporate the map viewing services into the client application (e.g., ridehailing application 172) to enable passengers to view the AV 102 in transit to a pick-up or drop-off location, and so on.

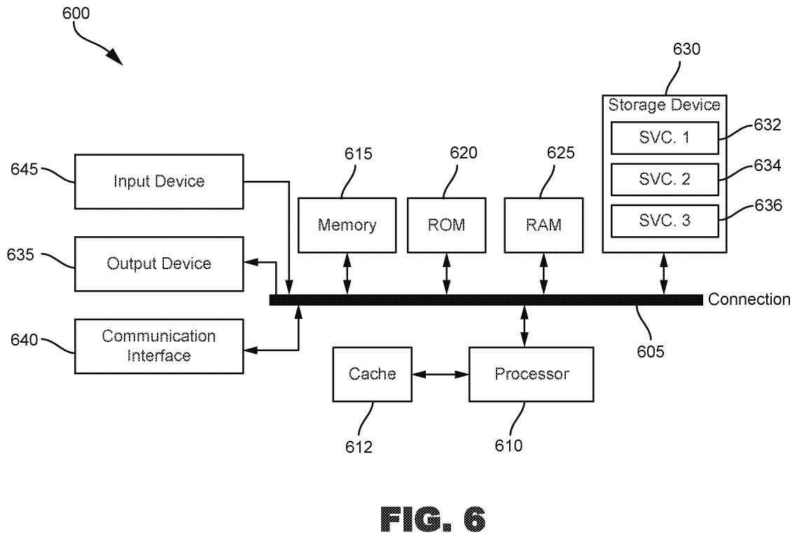

While the AV 102, the local computing device 110, and the autonomous vehicle environment 100 are shown to include certain systems and components, one of ordinary skill will appreciate that the AV 102, the local computing device 110, and/or the autonomous vehicle environment 100 can include more or fewer systems and/or components than those shown in FIG. 1. For example, the AV 102 can include other services than those shown in FIG. 1 and the local computing device 110 can, in some instances, include one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 6.

As previously noted, the AV 102 can use AI/ML models to make decisions, generate outputs, perform calculations, perform tasks, and/or make predictions used by the AV to navigate the environment. However, in some cases, the AV 102 can experience an error event that may trigger the AV 102 to request and/or receive human assistance to overcome the error event. For example, the AV 102 can experience an error event that causes the AV 102 to stop and remain stuck in a scene (e.g., unable to continue navigating or complete a maneuver without assistance). Here, the AV 102 may be unable to autonomously address/handle the error event (e.g., continue navigating a route, stop being stuck, etc.), and may need assistance from a human, such as a remote assistance operator.

For example, if the AV 102 is unable to detect a traffic signal (e.g., a traffic signaling device and/or a signal of the traffic signaling device) in an intersection or the traffic signal is not functioning, the AV 102 may decide to stop rather than crossing the intersection because the AV 102 has not detected a signal from the traffic signal indicating that the AV 102 can cross the intersection. In this example, the AV 102 may remain stuck/stopped and may need assistance from a remote assistance operator to traverse the intersection, as the remote assistance operator can instruct the AV 102 whether to remain stopped, cross the intersection despite the failure to detect a signal from the traffic signal, or perform another maneuver. When (e.g., before, during, and/or after) requesting and/or receiving assistance from the remote assistance operator, the AV 102 can provide a remote assistance system used by the remote assistance operator data collected by the AV 102 in the scene, such as sensor data, that the remote assistance operator can use to understand the scene, understand the AV's need for assistance, and/or determine how to assist the AV 102.

For example, the remote assistance operator may analyze data from the AV 102 describing the scene and/or the state of the AV 102, to determine whether the AV 102 can actually proceed through the intersection despite the lack of such an indication (or failure by the AV 102 to detect such an indication) by the traffic signal. The remote assistance operator can provide the AV 102 instructions on how to proceed (e.g., how and/or whether to cross the intersection, etc.). In some examples, the remote assistance operator can instruct the AV on how to proceed by sending data (e.g., a command or instruction, routing/navigation data, parameters, etc.) to the AV 102 that the AV 102 can use to overcome the error event (e.g., to continue through the intersection). The data from the remote assistance operator can include, for example and without limitation, instructions (e.g., a command(s), a task(s), etc.), routing/navigation data, parameters, etc.

The remote assistance operator can provide remote assistance to the AV 102 using a remote assistance system that provides a remote assistance interface that allows the remote assistance operator to remotely provide instructions to the AV 102 in order to assist the AV 102. The remote assistance system may provide data from the AV 102 (e.g., sensor data, log data, planning data, model outputs, etc.) to a display device that the remote assistance operator can use to analyze the data via the remote assistance interface, in order to determine how to assist the AV 102. The remote assistance operator can provide inputs through the remote assistance interface to remotely assist the AV 102. However, some of the data from the AV 102 that a remote assistance operator may need to rely on to assist the AV 102 may not be intuitive to a remote assistance operator (e.g., some of the data may not be intuitive to a human), may be difficult for a remote assistance operator (e.g., a human) to understand, or may be unintelligible to a remote assistance operator. For example, it is generally easier for a human to understand visual data depicting a scene of the AV 102, semantic elements in the scene, and any events in the scene than other non-visual data, data without labels/descriptions of semantic elements (or with labels/descriptions configured for consumption by the local computing device 110 that may not be intuitive to a human), and/or other type of data that may be used by an AI/ML model(s) of the AV 102 to perform AV tasks such as perception, planning, navigation, etc. In many cases, the data from the AI/ML model(s) of the AV 102 may be difficult for a human to understand or interpret as it may not be in a form, structure, format, scheme, etc., that is intended for human consumption (e.g., is intended for use or processing by a computer of the AV 102) and/or that can be understood by a human (or easily understandable to a human).

To illustrate, an output from an AV model(s) describing one or more navigation options of the AV 102 and/or one or more navigation decisions of the AV 102 may include a string(s) of values (e.g., numeric values, non-numeric values, etc.). The AV software (and/or associated AV models) may be configured to understand, interpret, and process the string(s) of values, which may be difficult for a human to understand/interpret or may even be unintelligible to a human. For example, an output from an AV model(s) regarding an intersection that the AV 102 is approaching (or has approached) can include one or more values representing one or more navigation options estimated by the AV model(s) for the AV 102, and one or more costs (e.g., weights, probabilities, etc.) associated with the one or more values representing the one or more navigation options. Such one or more values may be difficult for a human to understand. Instead, such one or more values may be designed for consumption/processing by a computer of the AV and may not be designed for ease of human consumption/interpretation.

In some cases, the data from an AV model(s) may even be encrypted, obfuscated, or otherwise unintelligible to a human. For example, the data may include a hash value representing and/or encoding information about the scene, navigation options, costs (e.g., weights, probabilities) associated with the navigation options, conditions associated with the navigation options, navigation constraints, and/or any other information. The AV software may be able to understand and process the hash value. However, a human may not be able to interpret or understand the hash value and thus may miss information that can help the human assist the AV 102 or that the human may need to assist the AV 102. Moreover, data from different AV models and/or software may vary in format, type, structure, content, and/or any other way. This can further increase the difficulty for a human to understand or interpret data from different AV models and/or software. For example, the outputs from different AV models may not be standardized in a way that may make it easier or possible for a human to interpret or understand. Even if the data from different AV models and/or software can be reasonably understood by humans, the humans may need to be trained on how to interpret such non-standardized data, which can increase costs, and/or may not be able to interpret such data in a timely fashion given the often time-sensitive nature of remote assistance events experienced by AVs.

To facilitate a remote operator in providing assistance to the AV 102, the systems and techniques described herein can translate outputs from an AI/ML model of the AV 102 having a specific value(s), format, structure, schema, content, and/or configuration that the AV software can understand (and/or designed for processing by the AV software, such as an AI/ML model of the AV 102), to data interpreting the outputs and preparing the interpreted data in a manner (e.g., format, structure, schema, content, configuration, presentation, etc.) estimated to be easier to understand and/or interpret by a human than the outputs from the AI/ML model, such as visual data. In some cases, the systems and techniques described herein can translate outputs from different AI/ML models of the AV 102 and prepare the translated data in a standardized manner such that the prepared data from outputs of different AI/ML models can appear similar to remote assistance operators (thus reducing or eliminating training of remote assistance operators to understand and/or interpret different outputs from different AI/ML models) and/or can have one or more commonalities, such as a common format, structure, schema, configuration, presentation, characteristic, visualization, and/or any other commonalities.

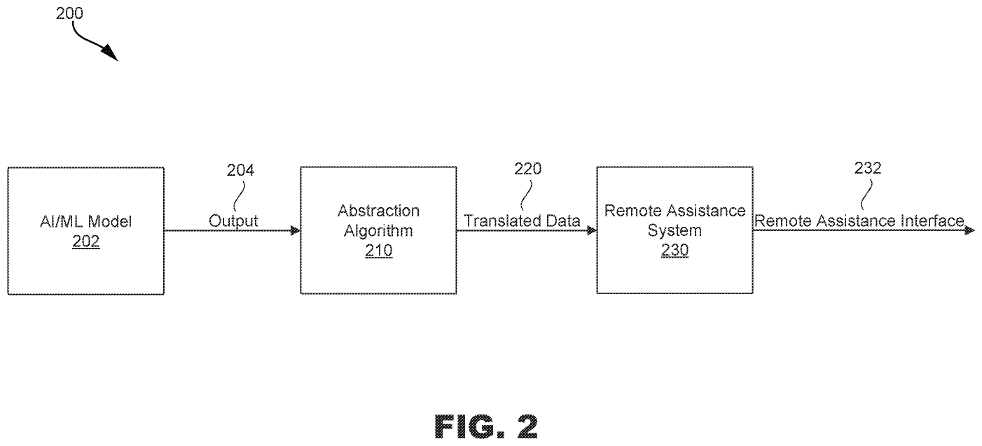

FIG. 2 is a diagram illustrating an example system flow 200 for translating outputs from AI/ML models of the AV 102 and generating remote assistance interface data based on the translated outputs from the AI/ML models, according to some examples of the present disclosure. In some examples, the system flow 200 can be implemented by an RA system in communication with the local computing device 110 of the AV 102 to translate outputs from AI/ML models and prepare the translated information for easier consumption, interpretation, and understanding by a human, such as an RA operator. The RA system can provide the prepared information to an RA interface that the RA operator can use to provide assistance to the AV 102. The prepared information can facilitate such assistance by translating the outputs from the AI/ML models and providing the translated information to the RA interface in a manner estimated to be easier for the RA operator to consume and understand.

In some cases, the system flow 200 can be used to provide RA data during an RA session between the AV 102 and an RA operator. The RA session can be triggered by an error event experienced by the AV 102. The error event can include any event that triggers a need or request for assistance of the AV 102. For example, the error event can include the AV 102 stopping along a route in response to a navigation constraint, an inability of the AV 102 to autonomously navigate a scene associated with a navigation constraint, a failure of the AV 102 to autonomously handle and/or resolve a navigation constraint, and/or any other scenario in which the AV 102 may need human assistance to perform a maneuver and/or navigate a scene associated with a navigation constraint. The navigation constraint can include any condition, rule, state, event, and/or restriction that may trigger the error event. For example, the navigation constraint can include any condition, rule, state, event, and/or restriction that the AV 102 can interpret as preventing the AV 102 from autonomously resuming navigation (e.g., resume movement) after stopping, autonomously navigating a scene associated with the navigation constraint, autonomously performing a maneuver associated with the navigation constraint, autonomously implementing a navigation action, resolving without human assistance, etc.

In some examples, the navigation constraint can include an actual constraint, such as a state of a traffic signal or an obstacle (e.g., a vehicle, a pedestrian, an animal, a condition in a scene, an object, etc.) in a scene, a failure or malfunction of a traffic signal, a signal from a human traffic controller, a condition in a scene, a traffic restriction, etc. In other examples, the navigation constraint can additionally or alternatively include a perceived constraint resulting from an error by the AV 102 in processing information about a scene and/or an incorrect AV software output (e.g., a detection output, a recognition output, a planning output, a tracking output, a prediction output, etc.), such as a failure by the AV 102 to detect a traffic signal (or a state of the traffic signal), an erroneous detection of an obstacle in a scene that can trigger an error event for the AV 102, a problem detecting a traffic control signal or object, an error understanding a navigation action(s) that the AV 102 can perform, an error or failure detecting one or more scene elements, etc.

As shown in the system flow 200, an AI/ML model 202 of the AV 102 can generate an output 204 configured for processing/consumption by the AV software of the AV 102. For example, the AI/ML model 202 can generate the output 204 as part of a task(s)/operation(s) by the AI/ML model 202 during operation of the AV 102. In some examples, the output 204 can relate to an error event experienced by the AV 102, a scene of the AV 102, a navigation decision of the AV 102, an operation of the AV 102, a prediction associated with an operation of the AV 102, a decision and/or detection associated with an operation of the AV 102, etc. The output 204 can provide information relevant to an error event encountered (or predicted to be encountered) by the AV 102 and/or an RA session associated with the error event. Thus, the information associated with the output 204 can be provided to an RA interface for use by an RA operator to assist the AV 102 during an RA session. However, the output 204 may be difficult or impossible for the RA operator to understand because of the format, structure, content, schema, configuration, and/or characteristic of the output 204.

For example, the output 204 from the AI/ML model 202 and outputs from one or more other AI/ML models of the AV 102 may not be standardized. The outputs from the AI/ML model 202 and other AI/ML models can differ in format, structure, content, schema, configuration, etc. As a result, it may be difficult for an RA operator to understand and/or interpret outputs from different AI/ML models, including the output 204. In some cases, RA operators may need additional training to understand and/or interpret unstandardized outputs from different AI/ML models.

Moreover, the output 204 from the AI/ML model 202 may be designed for processing, consumption, interpretation, etc., by the AV software of the AV 102, and may not be designed for ease of consumption by a human, such as a remote assistance (RA) operator. For example, in some cases, the output 204 can include a value(s) that represents a navigation decision generated by the AI/ML model 202, which can include a navigation action for the AV 102 to perform in a scene. To a human, the value(s) may not be easily understood as representing a navigation decision, and may even be encrypted or otherwise obfuscate the meaning of the value(s) thus making it harder for a human to understand. If the AV 102 experiences an error event that triggers an RA event (e.g., an RA request and/or an RA session), the AV 102 can send the value(s) (and any other data from the AV 102, such as sensor data collected by the AV 102) to an RA system for use by an RA operator to provide assistance to the AV 102. If the RA system provides the value(s) to an RA interface used by the RA operator to provide assistance to the AV 102, the RA operator may have difficulty understanding the value(s) (or may be unable to understand the value(s)), which can hamper the RA operator's ability to assist the AV 102. Accordingly, the system flow 200 can translate the value(s) and prepare the translated data for presentation in the RA interface in a manner that is better understood by the RA operator. This can help the RA operator better understand the data relating to the AV 102 and the error event, and provide assistance to the AV 102.

As another example, in some cases, the output 204 can include a cost map that includes data representing one or more navigation options for the AV 102 in a scene (e.g., one or more navigation actions that the AV 102 can perform in a scene) and a cost for each navigation option (e.g., a likelihood/probability that the AV 102 will select the navigation option). To illustrate, the cost map can include a key-value pair that provides a cost value for a navigation option in a scene. If the key-value pair is provided in the RA interface for the RA operator, the RA operator may have difficulty understanding the meaning of the key-value pair or may be unable to interpret the key-value pair. Thus, to assist the RA operator, the key-value pair can be translated and the translation can be prepared for presentation at the RA interface in a manner designed for consumption by the RA operator, such as in a visual form.

In some cases, the output 204 can include a hash value encoding navigation information, such as a navigation decision or option, a cost associated with the navigation decision or option, etc. Here again, the RA operator would have difficulty interpreting the hash value or may be unable to interpret the hash value. Accordingly, the hash value can be interpreted and the interpreted data can be prepared in a manner designed for consumption by the RA operator.

Moreover, the content of the data generated and processed by AI/ML models, such as the output 204 from the AI/ML model 202, can differ from the data that humans may expect and/or are generally experienced consuming. For example, the data from AI/ML models, such as the output 204, can include costs (e.g., weights) for corresponding information that an AI/ML model can interpret as bias weights and/or probabilities associated with such information. However, it can be difficult for an RA operator to provide assistance to the AV 102 by manipulating costs and/or using the costs to determine how to assist the AV 102 (and/or the reason for the error event that triggered an RA session). Instead, an RA operator may be trained to and/or better able to assist the AV 102 by removing or overturning constraints and/or AV decisions associated with the error event. The RA operator may also be better able to understand constraints and/or decisions that the RA operator can remove or overturn to assist the AV 102 than costs generated by an AI/ML model. Accordingly, in some examples, the system flow 200 can translate one or more costs in the output 204 from the AI/ML model 202 into a constraint and/or decision that the RA operator can remove or overturn to assist the AV 102 resolve the error event.

In the system flow 200 shown in FIG. 2, an abstraction algorithm 210 can receive the output 204 from the AI/ML model 202, and translate the output 204 to generate translated data 220 that an RA system 230 can prepare for presentation to an RA operator as further described herein. In some cases, the abstraction algorithm 210 can process the output 204 to generate the translated data 220, which the RA system 230 can prepare for presentation at an RA interface for use by an RA operator to provide assistance to the AV 102 as part of an RA session triggered by an error event experienced by the AV 102. In some examples, the abstraction algorithm 210 can translate the output 204 from a type of data designed for consumption by AV software (e.g., AI/ML models) to a type of data designed for human consumption (e.g., via the RA interface). For example, if the output 204 includes a value representing a navigation option, a navigation decision, and/or a cost associated with a navigation option or decision, the abstraction algorithm 210 can translate such value into a navigation constraint, such as a reason why the AV 102 may experience (or has experienced) an error event associated with the navigation option, the navigation decision, and/or the cost associated with the navigation option or decision. In this example, the translated data 220 can include, describe, and/or represent the navigation constraint.

To illustrate, if the output 204 includes a cost value indicating a probability that the AV 102 will implement a particular navigation option or decision, the abstraction algorithm 210 can determine if the cost exceeds a threshold. If the cost exceeds a threshold, the abstraction algorithm 210 can determine and/or assume that the AV 102 will implement the particular navigation option or decision even though the cost may not indicate that the AV 102 will implement the particular navigation option or decision but rather a probability that the AV 102 will implement such navigation option or decision. In other words, while the cost may not indicate complete certainty that the AV 102 will implement the navigation option or decision (e.g., the cost may not be dispositive regarding whether the AV 102 will implement the navigation option or decision), if the cost is above the threshold, the abstraction algorithm 210 can translate the cost to a determination and/or assumption that the AV 102 will implement the particular navigation option or decision. The abstraction algorithm 210 can additionally or alternatively translate the cost as a navigation constraint resulting (or estimated to result in) the AV 102 implementing the navigation option or decision. Thus, the translated data 220 can include an indication that the AV 102 will implement the particular navigation option or decision and/or an indication of the navigation constraint. This way, the RA system 230 can prepare the translated data 220 for presentation on an RA interface that conveys the information in the translated data 220, as further described below.

As another example, if the output 204 includes an encrypted or obfuscated value, such as a hash value, and the encrypted or obfuscated value represents a navigation option, a navigation decision, and/or a cost associated with a navigation option or decision, the abstraction algorithm 210 can translate such encrypted or obfuscated value into a navigation constraint, such as a reason why the AV 102 may experience (or has experienced) an error event associated with the navigation option, the navigation decision, and/or the cost associated with the navigation option or decision. Here, the translated data 220 can include, describe, and/or represent the navigation constraint. The RA system 230 can use the translated data 220 to prepare data for presentation on an RA interface as previously noted.

As yet another example, if the output 204 includes a string or key-value pair representing a navigation option, a navigation decision, and/or a cost associated with a navigation option or decision, the abstraction algorithm 210 can translate such string or key-value pair into a navigation constraint, such as a reason why the AV 102 may experience (or has experienced) an error event associated with the navigation option, the navigation decision, and/or the cost associated with the navigation option or decision. Here, the translated data 220 can similarly include, describe, and/or represent the navigation constraint, which the RA system 230 to prepare data for presentation on an RA interface as previously noted.

In some cases, the output 204 can include a value representing a navigation decision. The abstraction algorithm 210 can translate the value representing the navigation decision into the translated data 220. In this example, the translated data 220 can identify a navigation constraint attributed to (e.g., that caused or prompted) the navigation decision. The abstraction algorithm 210 can provide the translated data 220 to the RA system 230 for preparation for presentation at an RA interface.

In some cases, the output 204 can represent a cost map indicating the cost associated with a navigation decision or option. The abstraction algorithm 210 can translate the cost map into the translated data 220. For example, if the cost exceeds a threshold, the abstraction algorithm 210 can assume that the AV 102 will (or has) implemented the navigation decision or option associated with the cost. In some examples, the abstraction algorithm 210 can also determine a navigation constraint that triggered (or will trigger) the implementation of the navigation decision or option. The translated data 220 can thus interpret the cost (e.g., if the cost exceeds a threshold) as indicating that the AV 102 will implement (or has implemented) the navigation decision or option. Moreover, the translated data 220 can include, describe, and/or represent the navigation constraint that triggered (or will trigger) the implementation of the navigation decision or option. The abstraction algorithm 210 can provide the translated data 220 to the RA system 230 for preparation for presentation at an RA interface.

The RA system 230 can receive the translated data 220 and generate user interface data describing, including, and/or representing the translated data 220. In some examples, the RA system 230 can format, structure, configure, prepare, and/or package the user interface data in a manner estimated to be understandable by an RA operator viewing such data via the RA interface. For example, in some cases, the RA system 230 can generate user interface data that visually depicts, represents, and/or describes the translated data 220 for consumption by a human, who may have more ease understanding visual data than other type of data. The user interface data can additionally or alternatively include other type of data, such as descriptive data (e.g., a natural language description, etc.), that includes, represents, depicts, and/or describes the translated data 220.

For example, if the translated data 220 includes a navigation constraint determined to result in a decision to implement a navigation option (and/or determined to trigger or prompt selection of the navigation option), the user interface data generated by the RA system 230 based on the translated data 220 can include a visual user interface element depicting, representing, and/or describing the navigation constraint. To illustrate, if the navigation constrain is an intersection that prompted the AV 102 to stop at a stop location prior to the intersection, the user interface data generated by the RA system 230 can include a graphical user interface element depicting, representing, and/or describing the stop location and/or a stopping restriction at the stop location that is preventing the AV 102 from crossing the intersection even if the AV 102 may otherwise be allowed to cross the intersection (e.g., even if such restriction is not an actual restriction but a perceived restriction by the AV 102). The graphical user interface element can thus visually convey to the RA operator that the error event experienced by the AV 102 when implementing the navigation option was caused by the navigation constraint (e.g., the restriction at the stop location). Here, the navigation constraint can include, for example and without limitation, a determination that a traffic signal controlling traffic at the intersection has malfunction, a failure to detect a state of such a traffic signal, a detected instruction by a human traffic controller, a detected obstacle (e.g., a crosswalk, a pedestrian, a vehicle, an animal, an object, etc.) that the AV 102 interprets as restricting the ability or permission of the AV 102 to proceed through the intersection, a traffic and/or scene condition that the AV 102 interprets as restricting the ability or permission of the AV 102 to proceed through the intersection, and/or any other cause, condition, event, and/or information that the AV 102 may interpret as preventing the AV 102 from proceeding through the intersection.

The RA system 230 can use the prepared data (e.g., the user interface element and/or data) to generate, serve, and/or update an RA interface 230 associated with an RA session between an RA operator and the AV 102. The RA interface 230 can be displayed on a device associated with the RA operator. The RA operator can use the RA interface 230 to remotely assist the AV 102 in handling and/or overcoming the error event. For example, the RA system 230 can use the prepared data to update the RA interface 230 to include one or more interface elements generated based on the prepared data, such as interface objects, interface graphics, interface text, and/or other interface content to include, describe, represent, and/or depict one or more items and/or aspects of the prepared data (e.g., the navigation constraint, a navigation decision and/or option, an AV state, an error event, a navigation restriction, a semantic element associated with a scene, etc.).

In some examples, the one or more interface elements included in the RA interface 232 can depict, describe, represent, and/or include the prepared data (and/or a portion thereof), a constraint identified in the prepared data, an action identified in the prepared data, a condition identified in the prepared data, an AV state identified in the prepared data, an error event associated with the prepared data, a navigation restriction identified in the prepared data, a semantic element identified in the prepared data, etc. For example, if the prepared data identifies a navigation constraint that caused the error event (and thus triggered the RA session) and the navigation constraint includes and/or represents a stop location before an intersection that is interpreted/assumed (e.g., by the abstraction algorithm 210 via the translation of the output 204) to trigger the error event and/or interpreted/assumed to be perceived and/or treated by the AV 102 as requiring the AV 102 to stop at the stop location (e.g., assumed/interpreted by the abstraction algorithm 210 when translating a value in the output 204, such as a cost of a navigation option, into such navigation constraint).

The RA interface 232 can allow the RA operator to provide inputs regarding the one or more interface elements (and, optionally, regarding other aspects of the RA interface 232), to provide assistance to the AV 102. For example, the RA interface 232 can enable the RA operator to provide an input configured to remove, waive, dismiss, and/or reject the navigation constraint associated with the one or more interface elements and/or configured to generate an instruction for the AV 102 to ignore, dismiss, and/or reject the navigation constraint associated with the one or more interface elements.

In some examples, the one or more interface elements of the RA interface 232 can be interactive. For example, the one or more interface elements can be selected (e.g., by the RA operator) from the RA interface 232 for dynamic interaction (e.g., by the RA operator via the RA interface 232) with the one or more interface elements. The dynamic interaction with the one or more interface elements can include, for example and without limitation, manipulating (e.g., based on an input provided via the RA interface 232) the one or more interface elements and/or associated parameters, constraints, settings, behaviors, functions, and/or aspects; providing an input(s) to modify the one or more interface elements and/or associated parameters, constraints, settings, behaviors, functions, and/or aspects; providing input to select, activate, enable, and/or disable the one or more interface elements and/or associated parameters, constraints, settings, behaviors, functions, and/or aspects; providing input selecting to execute a task/operation associated with the one or more interface elements and/or selecting to prevent, stop, and/or modify execution of the task/operation; etc.

For example, if an interface element of the one or more interface elements includes a graphical object depicting a navigation constraint (e.g., a stop location perceived by the AV 102 to require the AV 102 to stop at the stop location, such as an intersection and/or an area associated with a traffic signal) that is identified in the prepared data (e.g., based on the translated data 220), the graphical object can be configured to allow the RA operator to modify the navigation constraint represented by the graphical object to trigger an instruction to the AV 102 configured to cause the AV 102 to implement one or more behaviors/maneuvers.

To illustrate, in the previous example, the graphical object can include, for example, a visual object (e.g., a line, a geometric shape, a pattern, a character, a button, a field, a control, etc.). The RA operator can provide an input selecting to remove the visual object. The RA system 230 can receive the input/selection and trigger an instruction to the AV 102 to ignore or waive the navigation constraint. By selecting to remove the visual object, such selection can trigger the RA system 230 to instruct the AV 102 to dismiss or remove the navigation constraint. If the AV 102 is stopped at a stop location because of the navigation constraint (e.g., a traffic signal and/or state, an intersection, a crosswalk, etc.) and such stoppage represents the error event, removing the navigation constraint can trigger the AV 102 to treat the navigation constraint as no longer requiring the AV 102 to stop at the stop location and thus resume navigation (e.g., cross/traverse the stop location). For example, the removal of the navigation constraint in can be interpreted by the AV 102 as instructing the AV 102 that the navigation constraint does not apply (or no longer applies) and thus the AV 102 no longer needs to remain stopped at the stop location.

As another example, if the input to the RA interface 232 instead moves the visual object within the RA interface 232 to a location within the RA interface 232 representing a location in the scene of the AV 102, the RA system 230 can interpret the move of the visual object as an instruction to move the stop location and send an instruction to the AV 102 indicating that the location associated with the navigation constraint has changed.

The RA system 230 can generate instructions to the AV 102 based on any interaction (e.g., input) with the one or more interface elements and/or other portions of the RA interface 232. The instructions can include, for example and without limitation, a command instructing the AV 102 to perform (or not perform) an action, a parameter (e.g., a navigation parameter, a planning parameter, etc.), a modification of a navigation constraint, a route modification, an instruction specifying one or more actions for the AV 102 to perform, a restriction, a flag, information associated with the error event and/or the AV 102, one or more data items, one or more signals, etc. For example, the RA system 230 can generate, based on an input associated with the one or more interface elements, an instruction to the AV 102 specifying whether to modify a navigation constraint, ignore or remove/dismiss the navigation constraint, accept (and/or continue implementing) the navigation constraint, etc.

In some examples, the RA system 230 can send the RA interface 232, content of the RA interface 232, and/or instructions to render the RA interface 232 to a device (e.g., a laptop, a desktop, a mobile phone, a tablet, a smart television, a kiosk, a server, a display, etc.) associated with the RA operator. The device can display the RA interface 232 for the RA operator and allow the RA operator to interact with the RA interface 232. In some cases, the RA system 230 can provide to the device the RA interface 232, content of the RA interface 232, and/or the instructions to render the RA interface 232 for presentation of the RA interface 232 at the device using server-side rendering, client-side rendering, and/or any other rendering scheme. In some examples, the RA operator can access the RA interface 232 via an application on the device, such as a remote assistance application, a web browser, a mobile application, and/or any other application.

The abstraction algorithm 210 can be implemented by the RA system 230 and/or a separate device/system. For example, in some cases, the RA system 230 can include and execute the abstraction algorithm 210. In other examples, the abstraction algorithm 210 can be hosted and/or executed by a separate device, such as a server, a datacenter, etc. The RA system 230 can include and/or be implemented by one or more computing systems such as, for example and without limitation, a server, a datacenter, a cloud computing system, a virtual machine, a software container, and/or any other computing system. An example of a computing system is further described below with respect to FIG. 6.

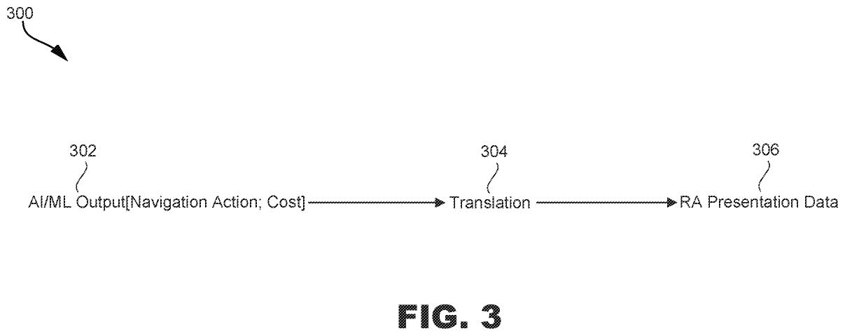

FIG. 3 is a diagram illustrating an example translation 300 of an AI/ML output 302, according to some examples of the present disclosure. In this example, the AI/ML output 302 identifies a cost associated with a navigation action. The cost can represent a likelihood that the AV 102 associated with the AI/ML output 302 will perform the navigation action and/or a weight used by the AV 102 as a bias to perform (or not perform) the navigation action.

The AI/ML output 302 (e.g., the cost associated with the navigation action) can be used to generate a translation 304 (e.g., via the abstraction algorithm 210) used to provide interface content to a device associated with an RA operator. For example, if the cost associated with the navigation action is above a threshold, the translation 304 can indicate that the AV 102 will implement the navigation action based on an assumption (and/or interpretation) that the AV 102 will implement the navigation action based on the cost being above a threshold. The cost associated with the navigation action may not specify whether the AV 102 will implement the navigation action, but if the cost is above the threshold, the translation 304 can nevertheless interpret the AI/ML output 302 as a decision to implement the navigation action (and/or as an indication that the AV 102 implemented or will implement the navigation action). In some cases, the AI/ML output 302 can include multiple costs associated with multiple navigation actions, and the translation 304 can identify the navigation action with the highest cost as the navigation action implemented (or that will be implemented) by the AV 102 from the multiple navigation actions.

By translating the AI/ML output 302 to identify a navigation action that the AV 102 is determined to have implemented or predicted to implement, the translation 304 can be used to generate RA presentation data 306 that can be displayed in an RA interface (e.g., RA interface 232) and can provide or include an interface element(s) identifying and/or representing the navigation output, which the RA operator can adjust via the RA interface to trigger an instruction to the AV 102 to implement (or not implement) the navigation action in order to assist the AV 102 to recover from and/or overcome an error event associated with the navigation action.

As noted above, the translation 304 can identify a navigation action that will be implemented by the AV 102 (or was implemented by the AV 102) based on the AI/ML output 302 (e.g., based on an interpretation of the AI/ML output 302, such as the cost and the associated navigation action). In some examples, the translation 304 can alternatively or additionally identify a navigation constraint (e.g., a detected condition and/or semantic element in a scene of the AV 102 interpreted by the AV 102 as imposing a navigation requirement or restriction, a failure to detect a condition and/or semantic element that the AV 102 expects to exist in the scene and the AV 102 expects to inform and/or instruct a behavior of the AV 102, a detected (or failure to detect) an object and/or obstacle in a scene of the AV 102 interpreted by the AV 102 as imposing a navigation requirement or restriction, etc.) determined and/or estimated to cause the AV 102 to implement the navigation action associated with the cost in the example AI/ML output 302. By translating the AI/ML output 302 to identify a navigation constraint associated with the navigation action, the translation 304 can be used to generate RA presentation data 306 that can be displayed in an RA interface (e.g., RA interface 232) and can provide or include an interface element(s) representing and/or depicting the navigation constraint, which the RA operator can adjust via the RA interface to trigger an instruction to the AV 102 estimated to assist the AV 102 to recover from and/or overcome an error event associated with the navigation action.

The translation 304 can be used to generate the RA presentation data 306, as previously noted. The RA presentation data 306 can provide, depict, and/or represent information from the translation 304, generated for presentation on an RA interface. In some cases, the RA presentation data 306 can include the RA interface and information presented in the RA interface based on the translation 304. In other cases, the RA presentation data 306 can include an interface element(s) (e.g., a field, a button, a selectable object, an input object, a content item, a frame, an interface object, etc.) that includes, represents, and/or depicts information and/or an action identified in the translation 304; a content item(s) associated with the translation 304; and/or any other interface data and/or elements associated with the translation 304.

In some examples, the RA presentation data 306 and/or the RA interface associated with the RA presentation data 306 can include other interface elements, content items, and/or any other interface data and/or elements associated with the AV 102 and/or an error event experienced by the AV 102. For example, the RA interface can additionally include a map and/or view of the AV 102 and/or the scene associated with the AV 102. The map and/or view of the AV 102 and/or the scene can be generated based on sensor data from the AV 102, such as image data collected by one or more image sensors of the AV 102, RADAR data collected by one or more RADAR sensors of the AV 102, LIDAR data collected by one or more LIDAR sensors of the AV 102, etc. The map and/or view can allow an RA operator to understand the scene associated with the AV 102 to determine and/or verify how to assist the AV 102 during an error event associated with an RA session.

For example, if the RA interface depicts a navigation constraint, such as a stop location at an intersection, that caused the AV 102 to stop and remain stuck/stopped (e.g., an error event), the RA operator can review the scene depicted in the RA interface to determine whether the navigation constraint can be removed. To illustrate, if the RA interface depicts a stop light associated with the stop location and the stop light is signaling that the AV 102 can proceed through the stop light, the RA operator can remove (e.g., via the RA interface) the navigation constraint representing the stop location associated with the stop light. The removal of the navigation constraint can allow the AV 102 to determine that the AV 102 no longer needs to stop or remain stop because of the stop light, which can trigger the AV 102 to proceed through the stop light (or perform another maneuver).

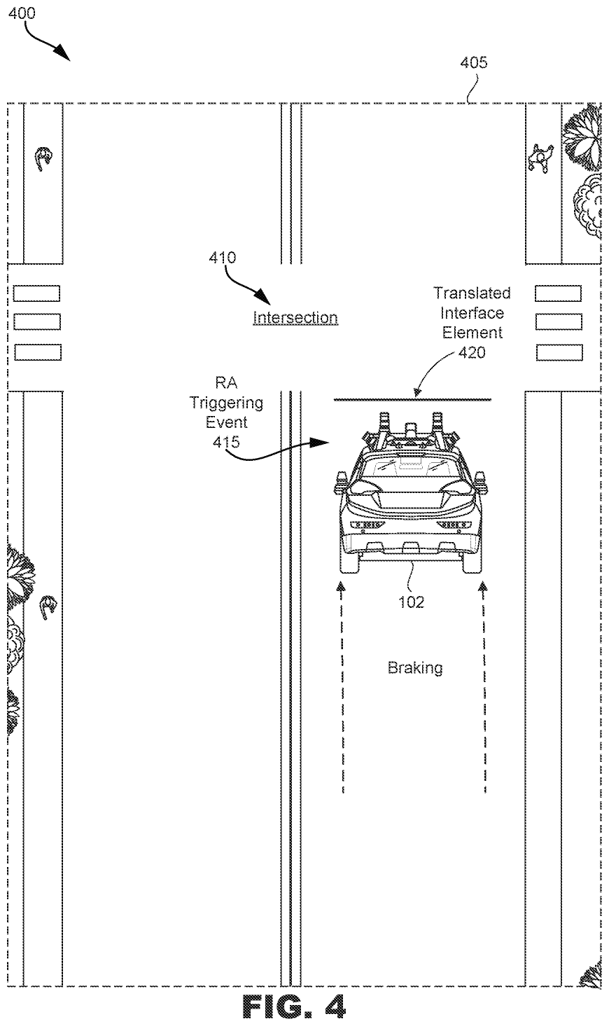

FIG. 4 is a diagram illustrating an example of an RA interface 400 generated based on a translation (e.g., translated data 220, translation 304) of an AI/ML model output (e.g., output 204, AI/ML output 302) and presented to a RA operator via a display such that the RA operator can control operation of an AV (e.g., AV 102). As previously noted, the translation can be used to generate RA interface data (e.g., RA presentation data 306).

In this example, the RA interface 400 depicts a view 405 of a scene of the AV 102 where the AV 102 encountered/experienced an error event, such as a failure to perform a navigation action and/or determine whether the navigation action (or what navigation action) the AV 102 can perform in the scene. The view 405 can include a map and/or graph of the scene of the AV 102, an image or video of the scene (e.g., as captured by one or more sensors of the AV 102), and/or any other visual representation of the scene, a route associated with the AV 102, a map associated with the scene, etc.

In this example, the view 405 depicts the AV 102 stopped prior to an intersection 410 in the scene. Here, the AV 102 has experienced an RA triggering event that has triggered an RA assistance session between the AV 102 and an RA operator using the RA interface 400 to provide assistance to the AV 102. The RA triggering event can include an error event that triggers a request or need for assistance. In the example shown in FIG. 4, the error event can include an event preventing the AV 102 from crossing the intersection 410. The error event can be triggered by, for example and without limitation, a failure of the AV 102 to detect a traffic signal controlling traffic associated with the intersection 410, failure of the AV 102 to detect a state/signal of a traffic signal (e.g., as a result of a perception/detection error experienced by the AV 102 or as a result of an error/malfunction of the traffic signal) associated with the intersection 410, an error by the AV 102 in determining whether the AV 102 can continue to/through the intersection 410, a cue that the AV 102 interprets as preventing the AV 102 from continuing to/through the intersection 410, remaining stopped at the stopped location for a threshold period of time which indicates that the AV 102 is stuck and/or needs assistance, a failure of detecting by the AV 102 a cue that the AV 102 interprets as a signal indicating that the AV 102 can proceed to/through the intersection 410, and/or any other factor and/or navigation constraint that triggers the AV 102 to stop before the intersection 410 in need of assistance to determine how/whether to continue navigation.

The view 405 includes a translated interface element 420 that the RA operator can use to assist the AV 102. The translated interface element 420 can convey to the RA operator that the AV 102 has stopped (or will stop) prior to the intersection 410. Moreover, the translated interface element 420 can depict and/or represent a navigation constraint, such as a stop location, a stop signal, a stop restriction representative of a reason why the AV 102 stopped before the intersection 410, a semantic element representative of a reason why the AV 102 stopped before the intersection 410, a traffic rule associated with the stop location, and/or any other navigation constraint.

From the view 405, the RA operator can navigation constraint associated with the translated interface element 420 can be waived/dismissed, rejected, removed, and/or disabled. For example, the RA operator can see the intersection 410 from the view 405 to determine whether the AV 102 can proceed. To illustrate, the RA operator can see the intersection 410 and determine whether a current traffic and/or traffic pattern allows or prevents the AV 102 from proceeding, whether there is a traffic signal (e.g., a stop light, a stop sign, a signal from a human traffic controller, etc.) indicating that the AV 102 can or cannot proceed, whether there is a traffic signal that has malfunctioned, and/or otherwise verify whether the AV 102 can proceed.

If the RA operator determines (e.g., based on the view 405) that the AV 102 can proceed, the RA operator can determine that the navigation constraint associated with the translated interface element 420 can be waived, ignored, rejected, and/or removed, which can trigger the AV 102 to proceed as the navigation constraint is determined to be the cause for the AV 102 remaining stopped before the intersection 410 and in need of assistance. If the RA operator determines that the navigation constraint can be waived, ignored, rejected, and/or removed, the RA operator can provide an input to the RA interface 400 to modify the navigation constraint via the translated interface element 420. For example, the RA operator can select (e.g., via the RA interface 400) to remove the navigation constraint associated with the translated interface element 420, which can trigger an instruction to the AV 102 that instructs the AV 102 to ignore, reject, and/or remove the navigation constraint. To illustrate, the RA operator can provide an input (e.g., via the RA interface 400) configured to move or remove (e.g., by dragging the translated interface element 420 or any other input) the translated interface element 420 from its location within the view 405. The movement or removal of the translated interface element 420 can indicate that the navigation constraint associated with the translated interface element 420 and the intersection 410 can be ignored, removed, and/or rejected by the AV 102.

In another example, the RA operator can provide an input (e.g., via the RA interface 400) configured to select an option to dismiss, waive, and/or reject the navigation constraint associated with the translated interface element 420 (and/or remove the translated interface element 420, which can trigger removal of the associated navigation constraint. The selection of the option to dismiss, waive, and/or reject the navigation constraint associated with the translated interface element 420 can trigger an instruction to the AV 102 indicating that the AV 102 can ignore, remove, and/or reject the navigation constraint associated with the translated interface element 420, which can allow the AV 102 to proceed and thus overcome the error event.

The translated interface element 420 can be generated based on a translation (e.g., translated data 220, translation 304) of an output of an AI/ML model of the AV 102, as previously explained. For example, if the output from the AI/ML model indicates a cost above a threshold associated with the navigation action of stopping before the intersection 410, the translation can interpret such cost associated with the navigation action as a navigation constraint that will cause (or has caused) the AV 102 to stop before the intersection 410. Based on such translation, the RA system (e.g., RA system 230) can generate the translated interface element 420 depicting, describing, and/or representing such navigation constraint. The RA system can then configure the RA interface 400 to display the translated interface element 420.

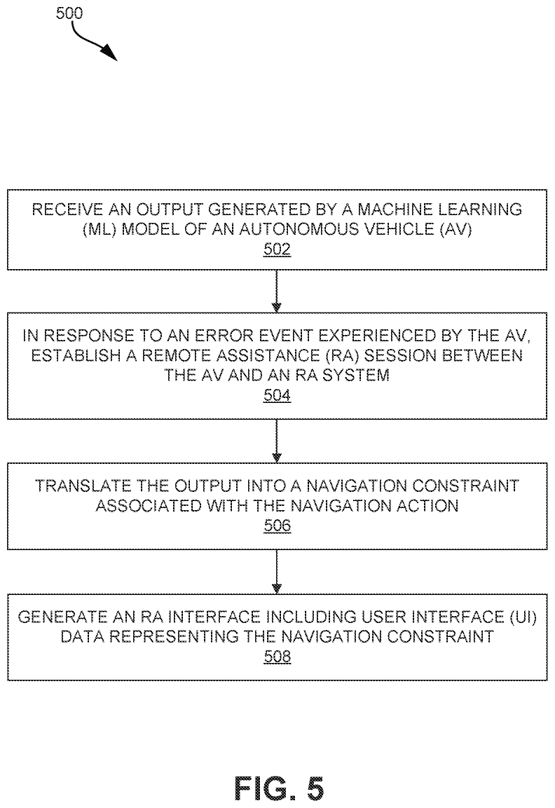

FIG. 5 is a flowchart illustrating an example process 500 for translating outputs from AI/ML models of an AV (e.g., AV 102) and generating RA interface data based on the translated outputs from the AI/ML models, according to some examples of the present disclosure. At block 502, the process 500 can include receiving an output (e.g., output 204, AI/ML output 302) generated by an AI/ML model (e.g., AI/ML model 202) of an AV (e.g., AV 102). In some examples, the output can indicate a navigation action analyzed/considered by the AV and/or a likelihood that the AV will implement the navigation action in a scene associated with the AV.

In some examples, the navigation action can include stopping by the AV. For example, the navigation action can include stopping before an intersection, stopping before a crosswalk, stopping for an obstacle (e.g., an object, a pedestrian, a vehicle, a construction zone, an animal, etc.), changing lanes, turning, stopping in a scene, etc.

At block 504, the process 500 can include in response to an error event experienced by the AV, establishing a remote assistance (RA) session between the AV and an RA system (e.g., RA system 230). The error event can be associated with the navigation action.

In some examples, the error event can include and/or be triggered by a need of the AV for remote assistance, a failure by the AV to continue navigation after stopping because of the navigation condition, a failure by the AV to continue navigation after stopping for a threshold period of time, an object detection error, and/or any other error experienced by the AV that may prevent the AV from autonomously implementing a different navigation action (or any navigation action).

At block 506, the process 500 can include translating the output into a navigation constraint associated with the navigation action. In some examples, the navigation constraint can represent a condition deemed to restrict a behavior of the AV in the scene to the navigation action and/or trigger the AV to implement the navigation action. In some aspects, translating the output into the navigation constraint can include interpreting a cost in the output as indicating that the AV will implement (or has implemented) the navigation action and determining the navigation constraint based on a determination (e.g., based on the cost) that the AV will implement (or has implemented) the navigation action. The cost can indicate or represent the likelihood that the AV will implement or has implemented the navigation action.

At block 508, the process 500 can include generating an RA interface (e.g., RA interface 232, RA interface 400) that includes user interface (UI) data representing the navigation constraint. The RA interface is associated with the RA session. For example, the RA interface can be used by an RA operator during the RA session to provide assistance to the AV to recover from the error event. In some cases, the UI data can include a UI element that visually depicts a stop location, a traffic boundary, a line representing the stop location and/or the condition associated with the navigation constraint, the navigation constraint, a state of the AV, and/or a geometric shape representing the condition associated with the navigation constraint.

In some examples, the RA interface can include a view (e.g., view 405) of the scene generated based on sensor data from the AV. In some cases, the sensor data can include image data from an image sensor, data from a LIDAR sensor, data from a RADAR sensor, data from a time-of-flight (TOF) sensor, and/or data from an ultrasound sensor. In some cases, the UI data can include an interactive UI element. The interactive UI element can include, for example, an input control element (e.g., a button, a field, etc.) and/or an interactive UI object.

In some aspects, the process 500 can include providing the RA interface to a device used by an RA operator to remotely assist the AV with the error event associated with the RA session. The device can include any computing device with display capabilities such as, for example and without limitation, a laptop computer, a desktop computer, a mobile phone, a tablet computer, a smart television, etc.

In some aspects, the process 500 can include receiving an input provided by the RA operator via the RA interface; generating an instruction configured to trigger the AV to ignore, remove, or reject the condition associated with the navigation constraint and implement a different navigation action; and sending the instruction to the AV. In some examples, the input can be configured to adjust the navigation constraint represented by the UI data. For example, the input can be configured to remove, reject, and/or dismiss the navigation condition and/or move, remove, reject, and/or dismiss a UI element representing the navigation constraint. The RA system can interpret the input as a request or instruction to the AV to ignore, remove, reject, and/or waive the navigation constraint to implement another navigation action that the AV would not otherwise implement because of the navigation constraint.

In some examples, the output can include a cost associated with the navigation action that represents the likelihood that the AV will implement the navigation action in the scene. In some aspects, the process 500 can include determining that the cost exceeds a threshold; in response to determining that the cost exceeds the threshold, determining that the AV has or will implement the navigation action; and translating the output into the navigation constraint based at least partly on the determining that the AV has or will implement the navigation action.

In some examples, the output can include a cost associated with the navigation action that represents the likelihood that the AV will implement the navigation action in the scene, and the process 500 can include in response to determining that a value of the cost exceeds a threshold, interpreting the cost as a decision to implement the navigation action; and translating the output into the navigation constraint based at least partly on the interpreting of the cost as the decision to implement the navigation action.

FIG. 6 illustrates an example processor-based system with which some aspects of the subject technology can be implemented. For example, processor-based system 600 can be any computing device making up local computing device 110, datacenter 150, a passenger device (e.g., client computing device 170) executing the ridehailing application 172, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some examples, computing system 600 is a distributed system in which the functions described in this disclosure can be distributed within a datacenter, multiple data centers, a peer network, etc. In some examples, one or more of the described system components represents many such components each performing some or all of the function for which the component is described. In some aspects, the components can be physical or virtual devices.

Example system 600 includes at least one processing unit (CPU or processor) 610 and connection 605 that couples various system components including system memory 615, such as read-only memory (ROM) 620 and random-access memory (RAM) 625 to processor 610. Computing system 600 can include a cache of high-speed memory 612 connected directly with, in close proximity to, and/or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 can include an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L #), resistive random-access memory (RRAM/ReRAM), phase change memory (PCM), spin transfer torque RAM (STT-RAM), another memory chip or cartridge, and/or a combination thereof.

Storage device 630 can include software services, servers, services, etc., that when the code that defines such software is executed by the processor 610, causes the system to perform a function. In some examples, a hardware service that performs a particular function can include the software component stored in a computer-readable medium in connection with the necessary hardware components, such as processor 610, connection 605, output device 635, etc., to carry out the function.

As understood by those of skill in the art, machine-learning techniques can vary depending on the desired implementation. For example, machine-learning schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:
Aspect 1. A system comprising: memory; and one or more processors coupled to the memory, the one or more processors configured to: receive an output generated by a machine learning (ML) model of an autonomous vehicle (AV), the output indicating at least one of a navigation action analyzed by the AV and a likelihood that the AV will implement the navigation action in a scene associated with the AV; in response to an error event experienced by the AV and associated with the navigation action, establish a remote assistance (RA) session between the AV and an RA system; translate the output into a navigation constraint associated with the navigation action, the navigation constraint representing a condition deemed to restrict a behavior of the AV in the scene to the navigation action or trigger the AV to implement the navigation action; and generate an RA interface comprising user interface (UI) data representing the navigation constraint, wherein the RA interface is associated with the RA session.
Aspect 2. The system of Aspect 1, wherein the one or more processors are configured to: receive an input provided by the RA operator via the RA interface, wherein the input is configured to adjust the navigation constraint represented by the UI data; generate an instruction configured to trigger the AV to ignore, remove, or reject the condition associated with the navigation constraint and implement a different navigation action; and send the instruction to the AV.
Aspect 3. The system of any of Aspects 1 to 2, wherein the output comprises a cost associated with the navigation action that represents the likelihood that the AV will implement the navigation action in the scene, and wherein the one or more processors are configured to: determine that the cost exceeds a threshold; in response to determining that the cost exceeds the threshold, determine that the AV has or will implement the navigation action; and translate the output into the navigation constraint based at least partly on the determining that the AV has or will implement the navigation action.
Aspect 4. The system of any of Aspects 1 to 3, wherein the UI data comprises a UI element that visually depicts at least one of a stop location, a traffic boundary, a line representing at least one of the stop location and the condition associated with the navigation constraint, the navigation constraint, a state of the AV, and a geometric shape representing the condition associated with the navigation constraint.
Aspect 5. The system of any of Aspects 1 to 4, wherein the navigation action comprises stopping by the AV, and wherein the error event comprises at least one of a need of the AV for remote assistance, a failure by the AV to continue navigation after stopping because of the navigation condition, and a failure by the AV to continue navigation after stopping for a threshold period of time.
Aspect 6. The system of any of Aspects 1 to 5, wherein the RA interface comprises a view of the scene generated based on sensor data from the AV, the sensor data comprising at least one of image data from an image sensor, data from a light detection and ranging (LIDAR) sensor, data from a radio detection and ranging (RADAR) sensor, data from a time-of-flight (TOF) sensor, and data from an ultrasound sensor.
Aspect 7. The system of any of Aspects 1 to 6, wherein the UI data comprises an interactive UI element, and wherein the interactive UI element comprises at least one of an input control element and an interactive UI object.
Aspect 8. The system of any of Aspects 1 to 7, wherein the output comprises a cost associated with the navigation action that represents the likelihood that the AV will implement the navigation action in the scene, and wherein the one or more processors are configured to: in response to determining that a value of the cost exceeds a threshold, interpret the cost as a decision to implement the navigation action; and translate the output into the navigation constraint based at least partly on the interpreting of the cost as the decision to implement the navigation action.
Aspect 9. The system of any of Aspects 1 to 8, wherein the one or more processors are configured to provide the RA interface to a device used by an RA operator to remotely assist the AV with the error event associated with the RA session.
Aspect 10. A computer-implemented method comprising: receiving an output generated by a machine learning (ML) model of an autonomous vehicle (AV), the output indicating at least one of a navigation action analyzed by the AV and a likelihood that the AV will implement the navigation action in a scene associated with the AV; in response to an error event experienced by the AV and associated with the navigation action, establishing a remote assistance (RA) session between the AV and an RA system; translating the output into a navigation constraint associated with the navigation action, the navigation constraint representing a condition deemed to restrict a behavior of the AV in the scene to the navigation action or trigger the AV to implement the navigation action; and generating, via the RA system, an RA interface comprising user interface (UI) data representing the navigation constraint, wherein the RA interface is associated with the RA session.
Aspect 11. The computer-implemented method of Aspect 10, further comprising: receiving an input provided by the RA operator via the RA interface, wherein the input is configured to adjust the navigation constraint represented by the UI data; generating an instruction configured to trigger the AV to ignore, remove, or reject the condition associated with the navigation constraint and implement a different navigation action; and sending the instruction to the AV.
Aspect 12. The computer-implemented method of any of Aspects 10 to 11, wherein the output comprises a cost associated with the navigation action that represents the likelihood that the AV will implement the navigation action in the scene, the method further comprising: determining that the cost exceeds a threshold; in response to determining that the cost exceeds the threshold, determining that the AV has or will implement the navigation action; and translating the output into the navigation constraint based at least partly on the determining that the AV has or will implement the navigation action.
Aspect 13. The computer-implemented method of any of Aspects 10 to 12, wherein the UI data comprises a UI element that visually depicts at least one of a stop location, a traffic boundary, a line representing at least one of the stop location and the condition associated with the navigation constraint, the navigation constraint, a state of the AV, and a geometric shape representing the condition associated with the navigation constraint.
Aspect 14. The computer-implemented method of any of Aspects 10 to 13, wherein the navigation action comprises stopping by the AV, and wherein the error event comprises at least one of a need of the AV for remote assistance, a failure by the AV to continue navigation after stopping because of the navigation condition, and a failure by the AV to continue navigation after stopping for a threshold period of time.
Aspect 15. The computer-implemented method of any of Aspects 10 to 14, wherein the RA interface comprises a view of the scene generated based on sensor data from the AV, the sensor data comprising at least one of image data from an image sensor, data from a light detection and ranging (LIDAR) sensor, data from a radio detection and ranging (RADAR) sensor, data from a time-of-flight (TOF) sensor, and data from an ultrasound sensor.
Aspect 16. The computer-implemented method of any of Aspects 10 to 15, wherein the UI data comprises an interactive UI element, and wherein the interactive UI element comprises at least one of an input control element and an interactive UI object.
Aspect 17. The computer-implemented method of any of Aspects 10 to 16, wherein the output comprises a cost associated with the navigation action that represents the likelihood that the AV will implement the navigation action in the scene, the method further comprising: in response to determining that a value of the cost exceeds a threshold, interpreting the cost as a decision to implement the navigation action; and translating the output into the navigation constraint based at least partly on the interpreting of the cost as the decision to implement the navigation action.
Aspect 18. The computer-implemented method of any of Aspects 10 to 17, further comprising providing the RA interface to a device used by an RA operator to remotely assist the AV with the error event associated with the RA session.
Aspect 19. A non-transitory computer-readable medium having stored thereon instructions which, when executed by one or more processors, cause the one or more processors to perform a method according to any of Aspects 10 to 18.
Aspect 20. A system comprising means for performing a method according to any of Aspects 10 to 18.

What is claimed is:

1. A system comprising:
a memory; and
one or more processors coupled to the memory, the one or more processors configured to:
receive an output generated by a machine learning (ML) model of an autonomous vehicle (AV), the output indicating at least one of a navigation action analyzed by the AV and a likelihood that the AV will implement the navigation action in a scene associated with the AV;
in response to an error event experienced by the AV and associated with the navigation action, establish a remote assistance (RA) session between the AV and an RA system;
translate the output into a navigation constraint associated with the navigation action, the navigation constraint representing a condition deemed to restrict a behavior of the AV in the scene to the navigation action or trigger the AV to implement the navigation action; and
generate an RA interface comprising user interface (UI) data representing the navigation constraint, wherein the RA interface is associated with the RA session.

2. The system of claim 1, wherein the one or more processors are configured to:
receive an input provided by the RA operator via the RA interface, wherein the input is configured to adjust the navigation constraint represented by the UI data;
generate an instruction configured to trigger the AV to ignore, remove, or reject the condition associated with the navigation constraint and implement a different navigation action; and
send the instruction to the AV.

3. The system of claim 1, wherein the output comprises a cost associated with the navigation action that represents the likelihood that the AV will implement the navigation action in the scene, and wherein the one or more processors are configured to:
determine that the cost exceeds a threshold;
in response to determining that the cost exceeds the threshold, determine that the AV has or will implement the navigation action; and
translate the output into the navigation constraint based at least partly on the determining that the AV has or will implement the navigation action.

4. The system of claim 1, wherein the UI data comprises a UI element that visually depicts at least one of a stop location, a traffic boundary, a line representing at least one of the stop location and the condition associated with the navigation constraint, the navigation constraint, a state of the AV, and a geometric shape representing the condition associated with the navigation constraint.

5. The system of claim 1, wherein the navigation action comprises stopping by the AV, and wherein the error event comprises at least one of a need of the AV for remote assistance, a failure by the AV to continue navigation after stopping because of the navigation condition, and a failure by the AV to continue navigation after stopping for a threshold period of time.

6. The system of claim 1, wherein the RA interface comprises a view of the scene generated based on sensor data from the AV, the sensor data comprising at least one of image data from an image sensor, data from a light detection and ranging (LIDAR) sensor, data from a radio detection and ranging (RADAR) sensor, data from a time-of-flight (TOF) sensor, and data from an ultrasound sensor.

7. The system of claim 1, wherein the UI data comprises an interactive UI element, and wherein the interactive UI element comprises at least one of an input control element and an interactive UI object.

8. The system of claim 1, wherein the output comprises a cost associated with the navigation action that represents the likelihood that the AV will implement the navigation action in the scene, and wherein the one or more processors are configured to:
in response to determining that a value of the cost exceeds a threshold, interpret the cost as a decision to implement the navigation action; and
translate the output into the navigation constraint based at least partly on the interpreting of the cost as the decision to implement the navigation action.

9. The system of claim 1, wherein the one or more processors are configured to provide the RA interface to a device used by an RA operator to remotely assist the AV with the error event associated with the RA session.

10. A computer-implemented method comprising:
receiving an output generated by a machine learning (ML) model of an autonomous vehicle (AV), the output indicating at least one of a navigation action analyzed by the AV and a likelihood that the AV will implement the navigation action in a scene associated with the AV;
in response to an error event experienced by the AV and associated with the navigation action, establishing a remote assistance (RA) session between the AV and an RA system;
translating the output into a navigation constraint associated with the navigation action, the navigation constraint representing a condition deemed to restrict a behavior of the AV in the scene to the navigation action or trigger the AV to implement the navigation action; and
generating, via the RA system, an RA interface comprising user interface (UI) data representing the navigation constraint, wherein the RA interface is associated with the RA session.

11. The computer-implemented method of claim 10, further comprising:
receiving an input provided by the RA operator via the RA interface, wherein the input is configured to adjust the navigation constraint represented by the UI data;
generating an instruction configured to trigger the AV to ignore, remove, or reject the condition associated with the navigation constraint and implement a different navigation action; and
sending the instruction to the AV.

12. The computer-implemented method of claim 10, wherein the output comprises a cost associated with the navigation action that represents the likelihood that the AV will implement the navigation action in the scene, the method further comprising:
determining that the cost exceeds a threshold;
in response to determining that the cost exceeds the threshold, determining that the AV has or will implement the navigation action; and
translating the output into the navigation constraint based at least partly on the determining that the AV has or will implement the navigation action.

13. The computer-implemented method of claim 10, wherein the UI data comprises a UI element that visually depicts at least one of a stop location, a traffic boundary, a line representing at least one of the stop location and the condition associated with the navigation constraint, the navigation constraint, a state of the AV, and a geometric shape representing the condition associated with the navigation constraint.

14. The computer-implemented method of claim 10, wherein the navigation action comprises stopping by the AV, and wherein the error event comprises at least one of a need of the AV for remote assistance, a failure by the AV to continue navigation after stopping because of the navigation condition, and a failure by the AV to continue navigation after stopping for a threshold period of time.

15. The computer-implemented method of claim 10, wherein the RA interface comprises a view of the scene generated based on sensor data from the AV, the sensor data comprising at least one of image data from an image sensor, data from a light detection and ranging (LIDAR) sensor, data from a radio detection and ranging (RADAR) sensor, data from a time-of-flight (TOF) sensor, and data from an ultrasound sensor.

16. The computer-implemented method of claim 10, wherein the UI data comprises an interactive UI element, and wherein the interactive UI element comprises at least one of an input control element and an interactive UI object.

17. The computer-implemented method of claim 10, wherein the output comprises a cost associated with the navigation action that represents the likelihood that the AV will implement the navigation action in the scene, the method further comprising:
in response to determining that a value of the cost exceeds a threshold, interpreting the cost as a decision to implement the navigation action; and
translating the output into the navigation constraint based at least partly on the interpreting of the cost as the decision to implement the navigation action.

18. The computer-implemented method of claim 10, further comprising providing the RA interface to a device used by an RA operator to remotely assist the AV with the error event associated with the RA session.

19. A non-transitory computer-readable medium having stored thereon instructions which, when executed by one or more processors, cause the one or more processors to:
receive an output generated by a machine learning (ML) model of an autonomous vehicle (AV), the output indicating at least one of a navigation action analyzed by the AV and a likelihood that the AV will implement the navigation action in a scene associated with the AV;
in response to an error event experienced by the AV and associated with the navigation action, establish a remote assistance (RA) session between the AV and an RA system;
translate the output into a navigation constraint associated with the navigation action, the navigation constraint representing a condition deemed to restrict a behavior of the AV in the scene to the navigation action or trigger the AV to implement the navigation action; and
generate an RA interface comprising user interface (UI) data representing the navigation constraint, wherein the RA interface is associated with the RA session.

20. The non-transitory computer-readable medium of claim 17, further comprising instructions stored thereon which, when executed by the one or more processors, cause the one or more processors to:
provide the RA interface to a device used by an RA operator to remotely assist the AV with the error event associated with the RA session;
receive an input provided by the RA operator via the RA interface, wherein the input is configured to adjust the navigation constraint represented by the UI data;
generate an instruction configured to trigger the AV to ignore, remove, or reject the condition associated with the navigation constraint and implement a different navigation action; and
send the instruction to the AV.
